(19) United States
(12) Patent Application Publication
(10) Pub. No.: US 2011/0054645 A1
(43) Pub. Date: Mar. 3, 2011

(54) SYSTEM AND METHOD FOR LATE REGISTRATION IN A POKER TOURNAMENT

(75) Inventor: Stuart Lewis-Smith, Moffat (GB)

(73) Assignee: ABSOLUTE TOKWIRO ENTERPRISES (ANTIGUA) INC., St. John's (AG)

(21) Appl. No.: 12/553,337

(22) Filed: Sep. 3, 2009

(51) Int. Cl. G06F 19/00

(52) U.S. Cl. 700/91

(57) ABSTRACT

A system and method for late registration for poker tournaments provides for seating late registrants at existing tables if possible, preferably each at a different table. When the existing tables run out of room, a new table is added, and the new late registrant sat there, as well as players from other tables, attempting to evenly distribute players over all tables. More late registrants are sat at the seats vacated by moving players to a new table. Late registration may be closed after a certain prespecified time, blind level, or number of late registrants are added.

### BACKGROUND OF THE INVENTION

1. Field of the Invention

The present invention relates to poker tournaments and, more specifically, to a system and method for late registration in poker tournaments.

2. The Prior Art

MTT is an abbreviation for Multi-Table Tournament, and indicates a tournament where play is occurring across multiple tables at once. MTTs are named as such to distinguish them from Single-Table Tournaments (STTs). In Multi-Table Tournaments, tables are slowly combined during the course of play as players are eliminated. Eventually, the tournament is reduced to a single table.

Online poker rooms offer a staggering array of MTTs on any given day. Most are scheduled and begin at a set time, but some are configured to begin when a set number of entrants register. The latter are referred to as MTT Sit and Go's, named for the fact that the tournament ‘goes’ when enough players are seated.

Prior to the merge into the Cereus Network, both Absolute Poker (AP) and UltimateBet (UB) had two different methods of players registering in tournaments that have already started. One method is Late Registration and the other is Alternates. The method of Late Registration has become an industry standard.

There are various methods for handling late registration employed by poker sites. Most of which are based on the same principals. In general they are as follows. In a late registration tournament, one or two seats are left vacant on each table to allow seats for late registrants. Players can register after the start of the tournament until either (a) the pre-defined time for late registration has ended, (b) a predefined number of blind intervals has occurred, (c) all the seats are filled, or (c) a player is eliminated.

The following describes the various methods of Late Registration employed by online poker sites.

Absolute Poker: In late registration tournaments, players will be seated at tables at the start of the tournament, with two seats left open per table for late registrants. Late registration will remain open until one of the following occurs: An existing player is knocked out of the tournament (this does not include players in re-buy tournaments who elect to re-buy). The end of the first level of blinds is reached or all of the seats left open for late registrants are filled.

UB's old system until November 2008 was called Alternate Registration (Old logic that was used on UB prior to the Cereus Merge): A player signing up after tourney has begun is placed on the alternate list in order in which they registered. When a player is eliminated, the next player is asked if they want to take a seat. If the player still wishes to play in the tourney, the seat in which the player that was just eliminated was sitting is reserved for the player on the alternate list. The amount of time available was configurable. UltimateBet dropped the Alternates method in favor of the Late Registration method used by Absolute Poker. This method was activated after the two sites merged on to the Cereus poker network, because two poker sites on the same network cannot have different late registration methods.

Poker Stars: Late registration is available till the first player is eliminated from the tourney. However, in tournaments with late registration enabled, a percentage of seats are kept free for late registrants (even after the first elimination). The number of seats made available for late registrants is calculated based on the total number of seats occupied when the tournament starts and the percentage is configurable.

Party Poker (Party Gaming): Registration is considered closed when any of the following occurs:
The first level of the tournament is completed.
One player is eliminated from the tournament.
All available seats are filled.
Maximum tournament capacity is reached.

Full Tilt: The late registration period for most tournaments ends when one of the following occurs:
The first blind level is complete.
The tournament is full.
The tournament is in the money.

Titan Poker (iPoker Network): Late registration is not allowed once a Multi-Table Tournament (MTT) has begun.

Tower Gaming (OnGame Network): Late registration is not allowed once a Multi-Table Tournament (MTT) has begun.

Absolute Poker (Cereus Network): Late registration will remain open until one of the following occurs:
An existing player is knocked out of the tournament.
The end of the first level of blinds is reached.
All of the seats left open for late registrants are filled.

Cake Poker (Cake Network): Late registration is time-based for freezeout tournaments and is always 15 min. Late registration for a Rebuy and Addon tournament is until the first break available.

Pacific Poker (888.com Network): Late registration is not allowed once a Multi-Table Tournament (MTT) has begun.

Everest Poker: Late registration is not allowed once a Multi-Table Tournament (MTT) has begun.

PKR: Multi-table tournaments are scheduled, and you must register for these tournaments prior to the posted start time. Registration for any given tournament closes a few minutes before the start of the tournament, after which time you can no longer register or unregister.

Bodog: Late registration will be allowed up until 10 minutes after the start of the tournament, unless the tournament fills up or the first player is eliminated.

### BRIEF SUMMARY OF THE INVENTION

A system and method for late registration for poker tournaments provides for seating late registrants at existing tables if possible where 1 or 2 seats were left open during seating of the players who registered on time, and each late registrant will be placed randomly at these open seats. When the existing tables run out of room, a new table is added, and the new late registrant sat there, as well as players from other tables, attempting to evenly distribute players over all tables. More late registrants are sat at the seats vacated by moving players to a new table. Late registration may be closed after a certain prespecified time, blind level, or number of late registrants are added.

### BRIEF DESCRIPTION OF THE DRAWINGS

FIG. 1 is a flowchart showing seating of a new player, in accordance with one embodiment of the present invention;

FIG. 2 is a flow chart illustrating configuration of a tournament, in accordance with one embodiment of the present invention;

FIG. 3 is a flowchart showing late registrant player seating, in accordance with one embodiment of the present invention;

FIG. 4 is a flowchart showing table creation, in accordance with one embodiment of the present invention; and

FIG. 5 is a block diagram illustrating a General Purpose Computer.

### DETAILED DESCRIPTION

The proposed change to the Absolute Poker/UltimateBet (AP/UB) provides an effectively unlimited number of late registrants who can join a poker tournament. Because of the system and method shown here to spawn new tables and the logic around seating at those tables, new tables can continue to be added as the number of players increases, until some prespecified limits are reached.

In the preferred embodiment of the present invention, players are able to register for a tournament after registration has ended. If a player registers late in a tournament, the buy-in and fees should be deducted from their account, and then a seat made available to sit and play in.

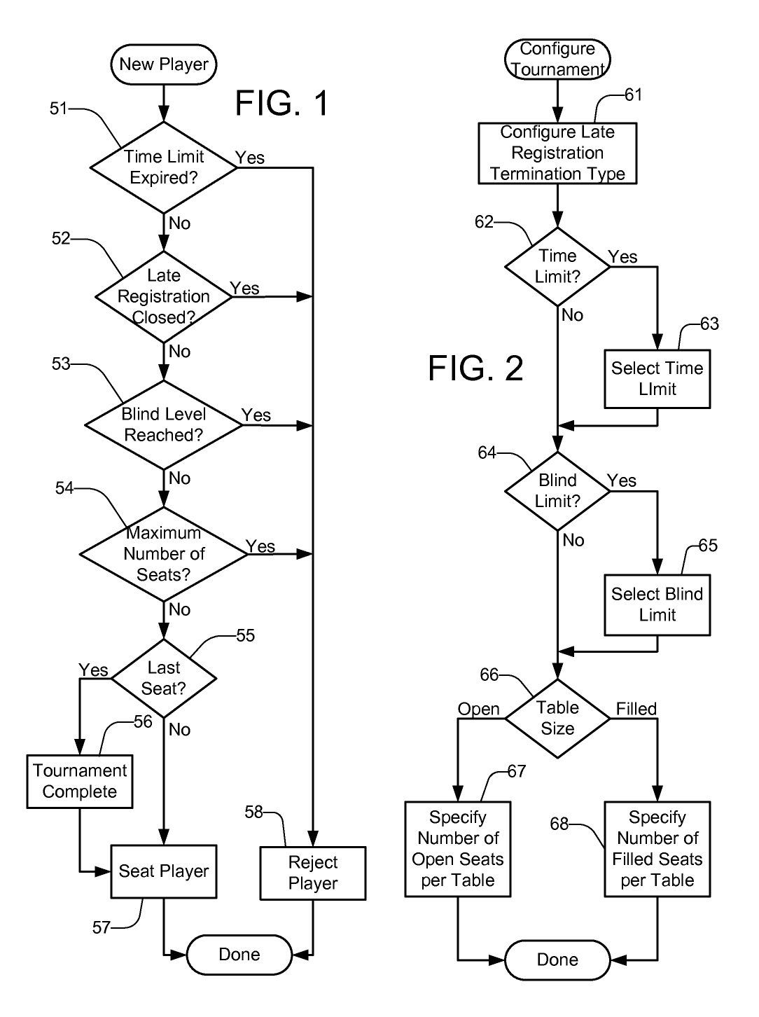

FIG. 1 is a flowchart showing seating of a new player, in accordance with one embodiment of the present invention. A check is made whether a time limit has expired, step 51. If the time limit has expired, seating the player is rejected, step 58. This time parameter is preferably configurable. When the time that is specified for late registration ends, players should preferably no longer be able to register for the tournament. A check is made whether registration is closed, step 52. If registration is closed, step 52, seating the player is rejected, step 58. A check is made whether a blind level has been reached, step 53. If the blind level has been reached, step 53, seating the player is rejected, step 58. This blind parameter is preferably be configurable. A check is made whether a maximum number of seats has been reached, step 54. If the maximum number of seats has been reached, step 54, seating the player is rejected, step 58. A check is made whether the last seat has been allocated, step 55. If the last seat has been allocated, step 55, the tournament is considered complete, and registration is closed, step 56. In either case, the player is seated, step 57, and his buy in and fees are deducted from his account. In any case, whether the player is seated 57 or not seated 58, the seating is complete.

FIG. 2 is a flow chart illustrating configuration of a tournament, in accordance with one embodiment of the present invention. The type of tournament is configured, step 61. A check is made whether the registration for the tournament has a time limit, step 62. If the registration for the tournament has a time limit, step 62, that time limit is specified, 63, typically in minutes, specifying how long late registration should be open. A pull down menu may be utilized to configure this parameter. A check is made whether there is a blind limit for the tournament, step 64. This is typically the number of blind escalations for which late registration is available. If there is a blind level for the tournament, step 64, this parameter is specified or selected, step 65. The blind level may be specified utilizing a pull down menu. A check is made what type of seating available is required, step 67. If the user wishes to specify the number of seats to remain open for late registrants, the number of open seats per table is specified, step 67. In one embodiment, this means that if a user selects that one seat should be available at each table for late registrants, then each table should start play with eight players. And, if the user selects that two seats should be available, then each table would start with seven players. Alternatively, if the user wishes to specify the number of initially filled seats at a table, that number is specified, step 68. In either case, the selection is preferably made with a pull down menu to specify the selection. Other methods of specifying these parameters are also within the scope of the present invention.

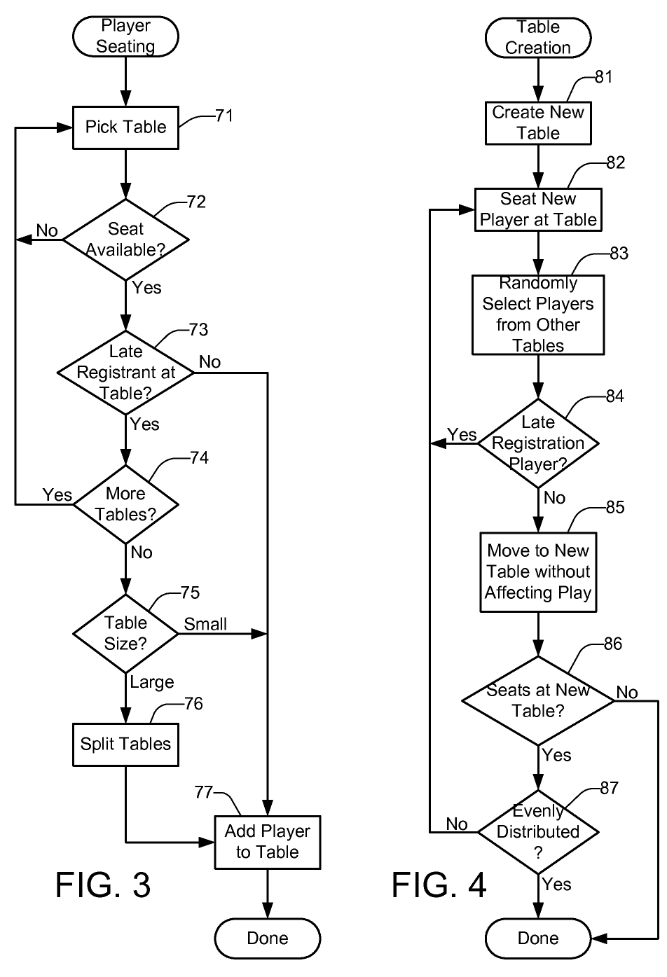

FIG. 3 is a flowchart showing late registrant player seating, in accordance with one embodiment of the present invention. It starts by selecting a table, step 71. A check is made whether there is a seat available at that table, step 72. If there is no seat available at that table, step 72, the next table is selected, step 71, and the loop repeats. Otherwise, a check is made whether there is already a late registrant at that table, step 73. If there is no late registrant at that table, step 73, the player is added to that table, step 77. Otherwise, a check is made whether there are any other tables available, step 74, and if there more tables available to check, step 74, the next table is selected, step 71, and the loop repeats. Otherwise, the smallest table is typically picked, and a check is made whether there are enough players at that table, step 75. If there are not enough players at that table, step 75, the player is added to that table, step 77. Otherwise, a table is split, step 76, and the new player is seated at one of the two resulting tables, step 77. For example, if a tournament has fewer than seven players, then new players could be added to the same table, while if the tournament has more than 7 but fewer than 17 players, and two players register at the same time, the table should preferably be split in two separate tables and the two late registrants placed at separate tables. Note that if there had already been a late registering player at that table before it was split, step 76, the new player would be seated at the other table from the other late registrant. One goal there is to minimize the number of late registrants at any table.

FIG. 4 is a flowchart showing table creation, in accordance with one embodiment of the present invention. This method may be utilized to seat late registering players at new tables when there are no seats available at the other tables. The new table is created, step 81. It should preferably be created without affecting game play. The new player is seated at the new table, step 82, without affecting game play. Another player is randomly selected from one of the other tables, step 83. If the player randomly selected is a late registrant, step 84, this player is skipped, and another player is randomly selected, step 83. Otherwise, that player is moved to the new table without affecting play, step 85. To the extent possible, late registration players should preferably not be moved to the new table. If there are more open seats at the new table, step 86 and the tables do not yet have evenly distributed players, step 87, another player is randomly selected, step 83, to be potentially moved to the new table, and the loop repeats. Henceforth, the openings at the various tables resulting from adding the new table can preferably be filled with other late registrants. The seats opened up by moving people from old tables to a newly created table are preferably the next seats filled by late registrants.

In the opposite case, when tables are collapsed, it is preferred if late registered players have their tables collapsed first. Thus, for example, the last player to register late would be the first to have his table collapsed in a tournament.

Players should preferably be ranked according to how many players are currently registered and playing in a tournament. Thus, for example:
100 players register for tourney prior to it starting.
Tourney begins with 100 players and late registration opens up while players begin the tourney.
First player loses and is ranked 100^{th} place.
3 players register for the tourney through late registration.
There are now 102 players in the tourney—99 players left that started the tourney plus the 3 players that registered late.
Next players loses and is ranked 102^{nd}.
Next player loses and is ranked 101^{st}.
Next player loses and is ranked 100^{th}.
Now there are two players tied for 100^{th} place.
This will preferably be allowed during late registration.

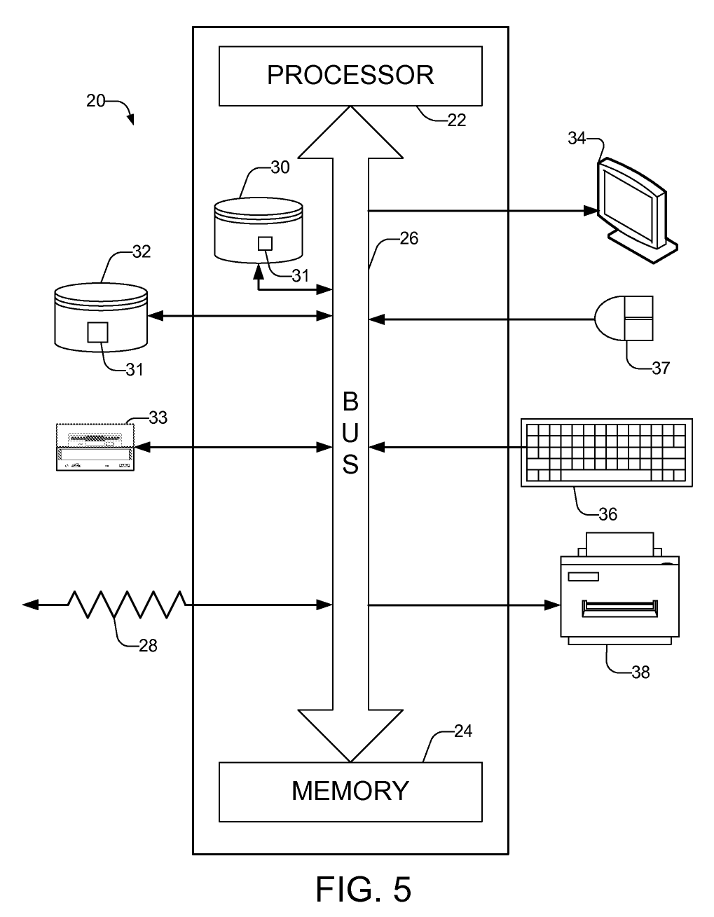

FIG. 5 is a block diagram illustrating a General Purpose Computer 20. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a monitor 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks 33, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such test programs, operating systems, and user programs can be stored in a Computer Software Storage Medium, such as memory 24, Secondary Storage 30, and External Storage 32. Executable versions of computer software 31, such as the system disclosed herein for seating poker tournament registrants can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution.

Those skilled in the art will recognize that modifications and variations can be made without departing from the spirit of the invention. Therefore, it is intended that this invention encompass all such variations and modifications as fall within the scope of the appended claims.

What is claimed is:

1. A method for seating late registrants in a poker tournament comprising:
receiving a request for a late registration for a new player for the poker tournament;
testing whether any of a set of termination conditions has been satisfied;
selecting a seat at a table for the new player as a selected seat at a selected table; and
seating the new player at the selected seat at the selected table if none of the set of termination conditions have not been satisfied.

2. The method in claim 1 wherein:
the set of termination conditions comprises:
a blind level; and
a time limit.

3. The method in claim 1 wherein the method further comprises:
adding a new table to the tournament;
seating the new player at the new table; and
moving a plurality of players from other tables to the new table without disrupting play.

4. The method in claim 3 wherein:
a number of players moved from other tables to the new table is selected to evenly distribute players to all of the tables in the tournament.

5. The method in claim 3 wherein:
a subsequent late registering player is seated at a seat at one of the other tables vacated when the plurality of players were moved to the new table.

6. The method in claim 3 wherein:
a new table is added when there are no empty seats at any of the other tables.

7. The method in claim 1 wherein the method further comprises:
selecting a table to collapse, wherein tables containing late registrants are collapsed before other tables; and
collapsing the table selected to be collapsed, moving players from the collapsing table to other tables in the tournament.

8. The method in claim 1 which further comprises:
accepting configuration of at least one of the set of termination conditions.

9. The method in claim 1 wherein:
players are originally seated at tables in the tournament leaving at least a prespecified number of open seats at each table in the tournament.

10. The method in claim 1 wherein:
when selecting tables to seat late registrants, tables are selected that do not yet have late registrants before tables that do have late registrants.
